(19) United States
(12) Patent Application Publication
(10) Pub. No.: US 2022/0080272 A1
(43) Pub. Date: Mar. 17, 2022

(54) Apparatus and System for Supporting a Golf Club

(71) Applicant: Christopher Nappe, Riverhead, NY (US)

(72) Inventor: Christopher Nappe, Riverhead, NY (US)

(21) Appl. No.: 17/532,211

(22) Filed: Nov. 22, 2021

Related U.S. Application Data
(63) Continuation-in-part of application No. 16/986,695, filed on Aug. 6, 2020, now Pat. No. 11,179,612.
(60) Provisional application No. 62/883,280, filed on Aug. 6, 2019.

(51) Int. Cl. A63B 55/10; A63B 57/30; F16M 11/04; F16M 11/10; F16M 11/26

(52) U.S. Cl. CPC A63B 55/10; A63B 57/353; A63B 2210/50; F16M 11/10; F16M 11/26; F16M 11/041

(57) ABSTRACT

Disclosed is a device for supporting a golf club. The device includes two telescoping legs that are attached to a body. A c-shaped clamp is formed as part of the housing and is dimensioned to be clipped onto the shaft of a golf club. With the telescoping legs extended, the legs and golf club head form a tripod. This arrangement allows the club to be supported in an upright position on the golf course and prevent the golf grip from getting dirty or wet.

### CROSS REFERENCE TO RELATED APPLICATIONS

This application claims priority to, and is a continuation-in-part of, co-pending application Ser. Number 16/986,695 filed on Aug. 6, 2020 and entitled “Apparatus and System for Supporting a Golf Club,” now U.S. Pat. No. 11,179,612 issued Nov. 23, 2021, which in turn claims priority to Provisional Application Ser. No. 62/883,280 filed on Aug. 6, 2019 and entitled “Device for Supporting a Golf Club”. The contents of these applications are fully incorporated herein for all purposes.

### BACKGROUND OF THE INVENTION

### Field of the Invention

The present disclosure relates to an apparatus and system for supporting a golf club upon the ground. More particularly, the present disclosure relates to an apparatus that supports the grip of a golf club when the golf club is placed upon the ground.

### Description of the Background Art

Golf is a game that is widely popular in the United States and abroad. This popularity has only increased in recent years. Golf is known for the intricacy of both its rules and etiquette. For example, USGA Rule 4, limits the number of clubs that can be used in a round as well as the conditions under which a club can be repaired during a round. Golf etiquette also places an emphasis on the speed of play. A player's golf bag, containing a variety of different clubs, is often transported around a course on the back of a golf cart. During a round, players will leave the cart and walk to the location of their ball. This is done to expedite play as the occupants of the golf cart will invariably be playing shots from different locations on the fairway. This means that the correct club must be selected without the benefit of the player being at the location of their ball. This is often difficult to do from the vantage point of the cart, as a player knows neither the exact yardage to the hole nor the lie of the ball. As a result, before leaving the cart, players often retrieve a number of clubs to ensure that they have the correct club for the shot.

Once at the ball, the correct club is selected, and the unused clubs are cast to the ground. These unused clubs remain on the ground until the conclusion of the shot. This phenomenon is especially true around the green, as golf carts are prohibited in these sensitive areas and the variety of clubs that may be needed is greater. In any event, the unused clubs are prone to getting wet, soiled, or muddy as they lie on the ground. The fertilizers used for fairways and greens may also degrade and otherwise prove detrimental to golf club grips. All of this adversely impacts subsequent shots. A golfer's only connection with the club is via the golf grip. Thus, grips that are wet, muddy, dirty, or degraded can result in mishits. Worse yet, it may prove dangerous to other golfers in the event the club slips out of the golfer's hand.

What is needed, therefore, is a small, transportable device that can support a club and its grip above a fairway or green. The apparatus described herein aims to overcome these and other shortcomings known in the golfing arts.

### SUMMARY OF THE INVENTION

It is therefore an object of the disclosure to provide a device that can prop a club up while it is not in use.

It is another object of this disclosure to provide a golf caddy device that is collapsible and easily transportable.

Yet another object of the disclosure is to provide a golf club support device that can be clipped to the user's hat, pants, or other clothing so that it is always within reach.

A further object of the disclosure is to provide a golf club support apparatus that includes two legs, with the legs of the support forming a tripod with the club head.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the apparatus for supporting a golf club.

FIG. 2 is a front elevational view of the apparatus for supporting a golf club.

FIG. 3 is a side elevational view of the apparatus for supporting a golf club.

FIG. 4 is an exploded view of the apparatus.

FIGS. 5-7 illustrate an alternative embodiment employing an integrated hook.

FIGS. 8-11 illustrate a further alternative embodiment wherein the club retainer can be secured at various angular orientations relative to the body.

Similar reference characters refer to similar parts throughout the several views of the drawings.

Parts List

20 Apparatus
22 Golf Club
24 Golf Club Shaft
26 Golf Club Grip
28 Golf Club Head
32 Clamp
32(a) Edges of Clamp
33 Arm
33(a) Aperture in Arm
34 Body
34(a) and 34(b) Sections of Body
34(c) Apertures in Body
35 Bearing
36 Legs
36(a) Apertures in Legs
38 Foot
40 Screws
44 Logo
46 Ball Marker
48 Upstanding Edges on Body
50 Clip
52 Clip Legs
54 Hooks at Ends of Clip Legs
64 Integrated Hook
66 Extension on Club Retainer
68 Tray within Body
70 Openings in Tray
72 Knobs on Extension
74 Grooves in Extension
76 Protrusions on Body
78 Opening in Body
82 Detents on Extension
84 Ridge on Body
86 Leg Stop
88 Detents for Legs

### DETAILED DESCRIPTION OF THE PREFERRED EMBODIMENT

The present disclosure relates to a system and apparatus for supporting a golf club. The apparatus includes two telescoping legs that are attached to a body. A clamp is pivotally attached to the housing and is dimensioned to be clipped onto the shaft of the club. With the telescoping legs extended, the legs and golf club head form a tripod. The angle between the shaft and the ground can be adjusted via the pivotal clamp. This arrangement allows the club to be supported at any of a number of different angles above the surface of a fairway or green. In this manner, the apparatus prevents the golf grip from getting muddy, dirty, or wet. The various components of the apparatus, and the manner in which they interrelate, are described in greater detail hereinafter.

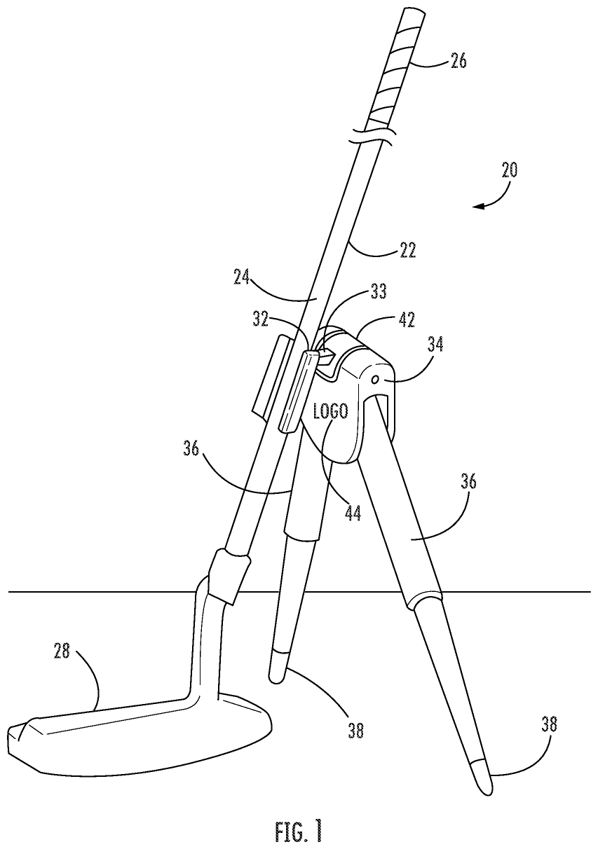

FIG. 1 illustrates the apparatus 20 supporting a golf club 22 upon the ground. Club 22 is defined by a club shaft 24, grip 26, and club head 28. As illustrated, apparatus 20 and club head 28 form a tripod that supports grip 26 above the ground. Although FIG. 1 illustrates apparatus 20 supporting a putter, it can readily be used with any club, including irons and drivers. As illustrated, apparatus 20 is connected to the club 22 along the club shaft 24. The user is free to position apparatus 20 anywhere along the length of shaft 24.

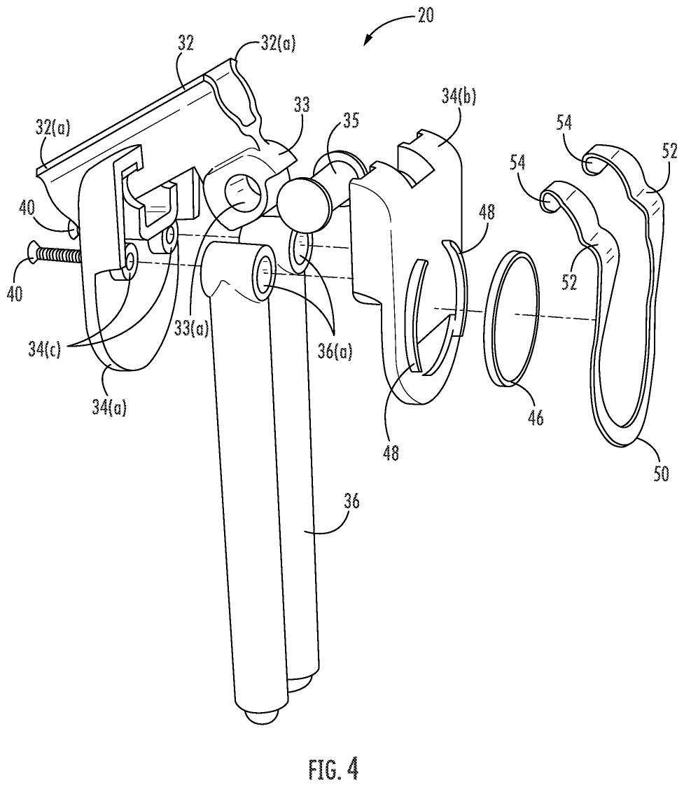

To facilitate this attachment, apparatus 20 includes a generally C-shaped clamp 32 that is frictionally and releasably attached to shaft 24. Clamp 32 is ideally formed from a plastic material and is dimensioned to fit over a standard sized golf shaft. Clamp 32 is preferably formed from a plastic that has a sufficient degree of flex to permit it to flex slightly between opened and closed orientations and allows clamp 32 to be frictionally fitted about shaft 24. To further facilitate the positioning of clamp 32 about shaft 24, the edges 32a of clamp 32 can be flared outwardly (FIG. 4). In the preferred embodiment, the user would apply a minimal force to open the mouth of clamp 32 and allow it to engage about shaft 24. Thereafter, an equal force would be applied to remove clamp 32 from shaft 24. Clamp 32 can be positioned at any of a number of locations long shaft 24, with the location helping determine the angle at which club 22 is supported.

In the preferred embodiment, apparatus 20 includes a body 34 to which clamp 32 is pivotally connected. Body 34 is formed from two opposing halves (34a and 34b) that are secured together via retaining screws 40. The first half of body 34(a) includes apertures 34(c) for receiving screws. The opposing halves (34a and 34b) define an internal area. Clamp 34 includes an arm 33 that is pivotally secured within this internal area. More specifically, a bearing is pivotally positioned within the internal area and is secured within an aperture 33(a) within arm 33. This allows the clamp 33 to pivot about the bearing 35. Bearing 35 can be made of metal to avoid wear or damage. The remainder of apparatus 20 can be form from an impact resistant plastic or metal. This, in turn, allows clamp 32 to be selectively moved between a number of different angular positions.

For example, clamp 32 can be pivotally oriented to the side of body 34 such that the mouth of clamp 34 is generally perpendicular to the ground. In this orientation, apparatus 20 supports club 22 in a more or less vertical arrangement. Alternatively, clamp 32 can be pivoted so that it is oriented over the top of the body 34 such that the mouth of clamp 34 is generally parallel to the ground. In this orientation, and with clamp 34 secured further up on the club shaft 24, the angle between the ground and club 22 is minimized. Thus, a wide variety of club orientations can be achieved by adjusting the angle of clamp 32 and its position along the club shaft 24.

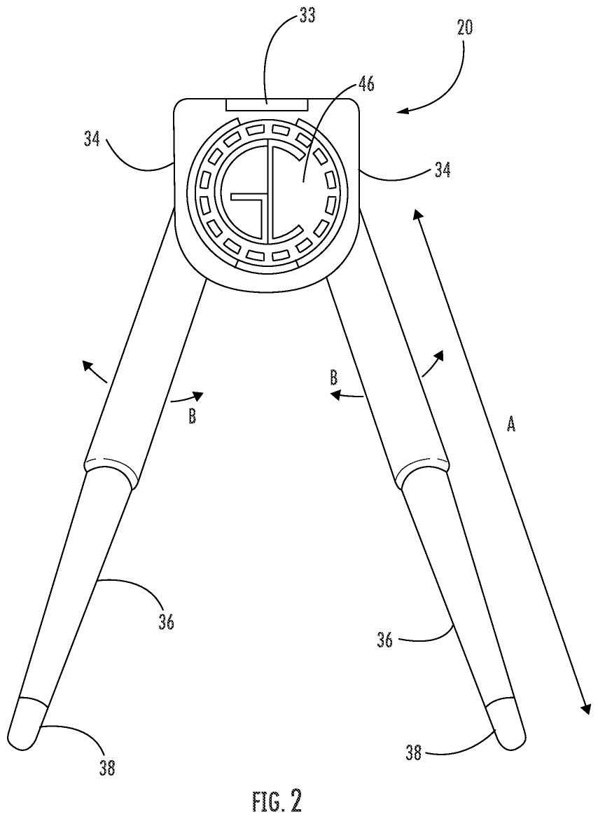

Two telescoping legs 36 are also pivotally connected to body 34. Although two legs 36 are illustrated, it is within the scope of the present disclosure to use three or more legs 36. In the depicted embodiment, each leg 36 includes two telescoping sections. More specifically, each leg 36 is formed from a larger tubular section (that is pivotally connected to body 34) and that receives a smaller tubular section. More specifically, the upper extent of each leg 36 terminates in an aperture 36(a). These apertures 36(a) are positioned within the internal area of body 34 and receive the retaining screws 40. This arrangement allows the legs 36 to pivot with respect to body 34 in a first direction. This direction is noted by arrows “B” in FIG. 2. The pivotal attachment between legs 36 and body 34 allows legs 36 to pivot toward or away from each other as shown by arrows “B.” This effectively allows the angle at which legs 36 diverge to be modified. The pivotal direction “B” is generally perpendicular to the pivotal movement of clamp 32. Each leg 36 terminates in a foot 38 that maybe rubberized and allows for the secure positioning of device 20 on the ground. However, different arrangements can be used for legs 36 as will be appreciated by those of ordinary skill in the art. As illustrated in FIG. 2, legs 36 telescope outwardly in the direction “A.” Both the telescoping direction “A” and the pivoting direction “B” can be selected based upon the terrain upon which club 22 is to be supported. Apparatus 20 can be placed into its collapsed orientation by retracting the telescoping legs 36 as well as by pivoting legs 36 together.

With reference to the exploded view of FIG. 4, an optional clip 50 can be pivotally secured to body 34. Clip 50 preferably includes two opposing legs 52 that terminate in hooks 54. These hooks are received within the internal area of body 34. This results in clip 50 pivotally attached to body 34. This arrangement allows apparatus 20 to be removably fastened to, for example, the user's clothing. To achieve this, device 20 is first fully collapsed by both retracting and pivoting legs 36 together. Once collapsed, device 20 can be clipped to a belt or hat so that it can be easily accessed as needed. Logo 44 or other indicia can also be printed upon body 34 so that device 20 can be used as a promotional tool. FIG. 4 also illustrates a ball marker 46 that is magnetically secured to the side of body 34. In this regard, one side of body 34(b) can include upstanding edges 48 to create a slot for receiving marker 46. A recess can be created within body 34(b) to allow marker to be push into and pivoted out of slot. Apparatus 20 is an ideal location for ball marker 46 as apparatus 20 would be carried by the golfer to the putting green.

In use, apparatus 20 can be carried or worn by the golfer while it is in a collapsed orientation. Apparatus 20 can be carried to the location where the golfer is going to play his or her next shot. The golfer next affixes apparatus 20 to any club 22 that is not being played. This is accomplished by frictionally fitting club shaft 24 into the mouth of C-shaped clamp 32. To accomplish this, the mouth of clamp 32 may have to be opened slightly. The golfer can secure apparatus 20 at any location along the length of shaft 24. Next, legs 36 are extended outwardly and pivoted away from one another. In this orientation, club 22, with apparatus 20 attached, can be placed on the ground. As noted in FIG. 1, this allows a tripod to be formed between legs 36 and club head 28. In this tripod arrangement, the grip 25 of the club 22 does not contact the ground.

### Alternative Embodiments

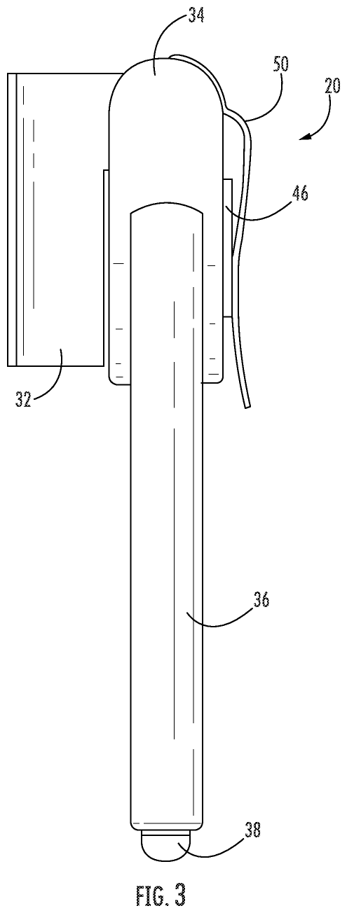

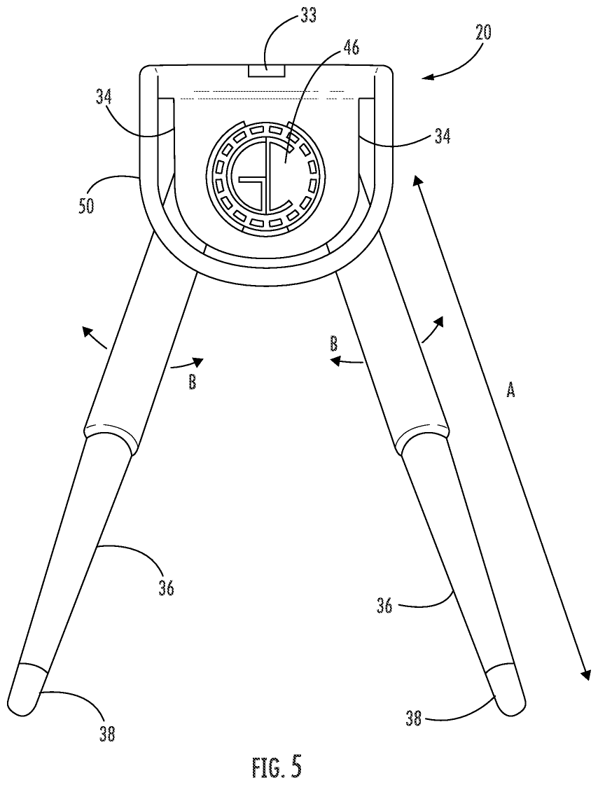

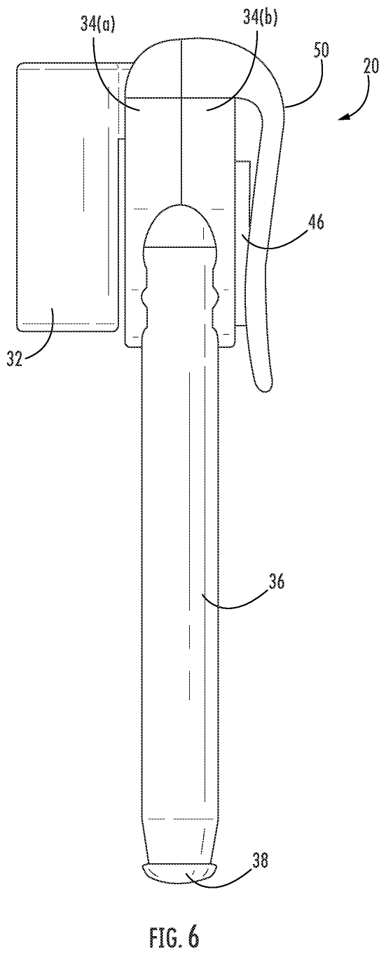

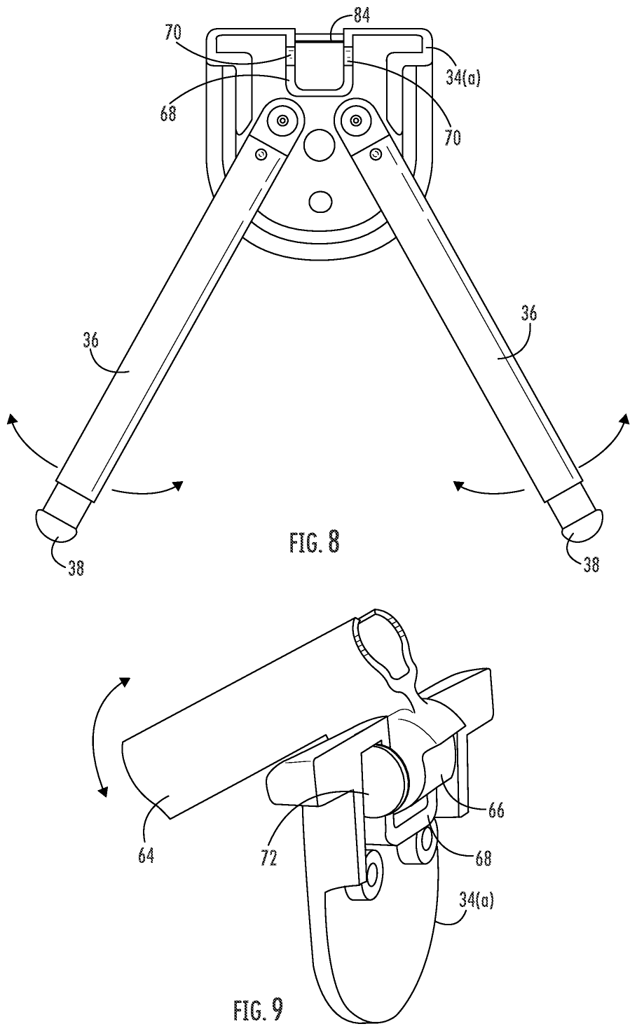

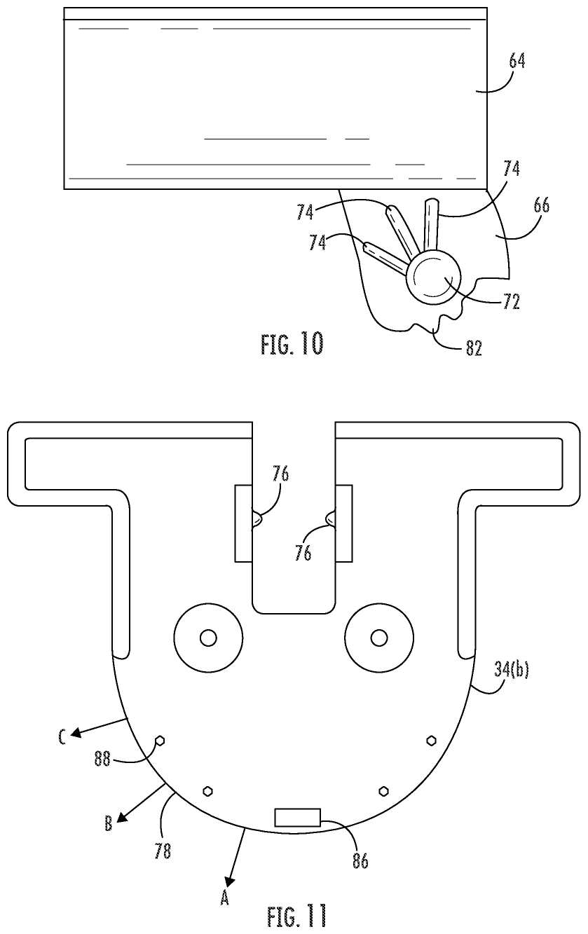

Some alternative embodiments of apparatus 20 are disclosed in FIGS. 5-11. Many of the components of these alternative embodiments are the same as those disclosed in FIGS. 1-4. As such, like reference numerals refer to the same or similar components in the drawings. However, in FIGS. 5-7, hook 62 is integrally formed with body 34. Specifically, body section 34(b) includes an U-shaped slot (FIG. 7) that is formed along its periphery. This U-shaped slot forms resilient hook 62. This integrated hook 62 is an alternative to clip 50, which in the primary embodiment is formed as a separate element to body 34. Hook 60 allows apparatus 20 to be conveniently secured to the player's clothing or golf bag.

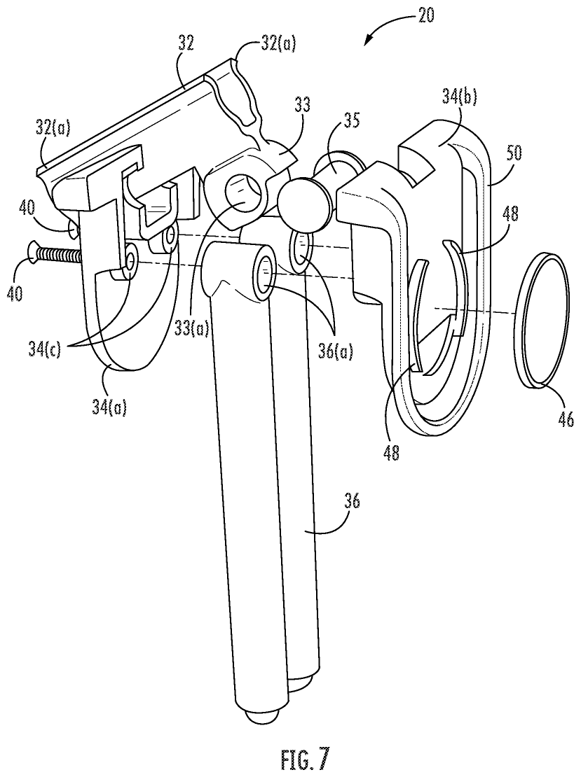

Further alternative embodiments are illustrated in FIGS. 8-11. In this embodiment, clamp 32 with its outwardly turned edges 34(a) (FIG. 4) is replaced with a softer and more resilient club retainer 64. Retainer 64 is cylindrical in shape and dispenses with the need for outwardly turned edges. Instead of being made from a rigid plastic, retainer 64 is made from a pliable material. It includes an elongated slit that allows retainer 64 to be secured to the club shaft. The resilient and soft nature of retainer 64 allows it to be fitted to a variety of shaft sizes and also eliminates any scratching of the club.

Retainer 64 further includes an extension 66 with opposing knobs 72. Extension 66 is adapted to be rotatably positioned within a tray 68 formed on an interior face of body 34(a) (FIG. 8). Tray 68 includes opposing openings 70 that are sized to receive the opposing knobs 72 of extension 66. Knobs 72 act as axles to permit extension 66 and retainer 64 to pivot relative to housing 34. Retainer further includes a series of grooves 74 on its opposing faces. These grooves 74 cooperate with protrusions 76 formed on body 34(b). As illustrated in FIG. 11, protrusions 76 extend outwardly from opposing walls of body 34(b) at a position that is opposite to tray 68. These protrusions 76 can be selectively positioned within grooves 74 to thereby allow the player to position retainer 64 at one of three distinct angular orientations. Additional angular orientations can be achieved by adding additional groves 74. A series of detents 82 are also formed along the back surface of extension 66. These detents 82 cooperate with a protrusion 84 formed upon a wall of housing section 34(b) (FIG. 8). Detents 82 are spaced to cooperate with grooves 74 and further secure retainer 64 at a particular angular orientation.

Housing 34(b) includes a leg stop 86 at its lower extent. When sections 34(a)/34(b) are brought together, they define leg openings 78 that their lower extent. Leg stop 86 prevents the legs from being pivoted too far inwardly. Detents 88 are also formed at spaced intervals along the leg openings 78. Legs 36 are sized to fit between these detents 88 (or between stop 86 and an adjacent detent 88; or between the upper end of leg opening 78 and an adjacent detent 88). By positioning each leg 36 between adjacent detents 88, angular positions A, B, and C for the legs 36 can be achieved. The desired angular position will depend upon the particular condition of the ground. Alternatively, each leg 36 may include a recess along its length that cooperates with spaced protrusions formed along the leg openings 78. These recesses and protrusions would likewise permit legs 36 to be locked into one or more detented positioned relative to housing 34.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. An apparatus for supporting a golf club, the golf club including a shaft, the apparatus comprising:
a body having first and second opposing faces;
a pair of legs, each leg including upper and a lower extents, the upper extent of each leg being pivotally connected to the body;
a clamp being pivotally connected to the body, the clamp dimensioned to be releasably and frictionally secured to the shaft of the golf club.

2. The apparatus as described in claim 1 further comprising a ball marker that is releasably secured to the body.

3. The apparatus as described in claim 1 wherein the legs are telescopically adjustable.

4. The apparatus as described in claim 1 wherein the clamp can be secured into one of a series of angular orientations relative to the body.

5. An apparatus for supporting a golf club, the golf club including a shaft, the apparatus comprising:
a body having first and second opposing faces, one of the opposing faces including opposing protrusions;
a pair of legs, each leg including upper and a lower extents, the upper extent of each leg being pivotally connected to the body;
a clamp being pivotally connected to the body, the clamp dimensioned to be releasably and frictionally secured to the shaft of the golf club;
the clamp including a series of recesses that cooperate with the opposing protrusions to selectively secure the clamp in one of several angular orientations relative to the body.
